(19) United States
(12) Patent Application Publication
(10) Pub. No.: US 2005/0118388 A1
(43) Pub. Date: Jun. 2, 2005

(54) Skin attachment member

(75) Inventor: Howard A. Kingsford, Amherst, NH (US)

Correspondence Address: FISH & RICHARDSON PC, 225 FRANKLIN ST, BOSTON, MA, 02110, US

(73) Assignee: Velcro Industries B.V., a Netherlands corporation

(21) Appl. No.: 11/027,540

(22) Filed: Dec. 30, 2004

Related U.S. Application Data
(62) Division of application No. 09/440,384, filed on Nov. 15, 1999.

(51) Int. Cl. B32B 3/06

(52) U.S. Cl. 428/99; 604/173; 424/449; 604/46

(57) ABSTRACT

A skin attachment member of plastic resin, includes a sheet-form backing, and an array of skin penetrating elements extending integrally from the backing. The skin penetrating elements are configured to penetrate into the epidermal skin layer and are sized to limit painful contact with nerves below the epidermal skin layer. At least many of the skin penetrating elements each include at least one retention barb extending from an outer surface of the skin penetrating element. The barbs are configured to cooperate to resist removal of the skin attachment member from skin. The skin penetrating elements have a cone-shaped body with a pointed tip. The skin penetrating elements can have a groove in their outer surface. The skin attachment member is formed by molding.

### BACKGROUND OF THE INVENTION

The invention relates to an attachment member for securing objects to skin.

A patch with an array of microneedles which penetrate into the stratum corneum is known. The microneedles are made out of silicon using the same etching process used to manufacture computer chips.

### SUMMARY OF THE INVENTION

The attachment member of the invention, formed of plastic resin, includes a base layer from which extend an array of many tiny, integral skin-penetrating plastic elements having one or more barbs which lodge in the skin and resist removal of the attachment member. The member is configured such that the elements securely fasten to the skin without penetrating deeply enough to cause pain and discomfort.

According to one aspect of the invention, a skin attachment member of plastic resin includes a sheet-form backing, and an array of skin penetrating elements extending integrally from the backing. The skin penetrating elements are configured to penetrate into the epidermal skin layer and are sized to limit painful contact with nerves below the epidermal skin layer. At least many of the skin penetrating elements each includes at least one retention barb extending from an outer surface of the skin penetrating element. The barbs are configured to cooperate to resist removal of the skin attachment member from skin.

Embodiments of this aspect of the invention may include one or more of the following features.

Each skin penetrating element has a cone-shaped body. The base of the cone-shaped body has a diameter of about 0.003″. Each skin penetrating element has a length of about 0.012″ and a pointed tip. The backing has a thickness in a range of about 0.003″ to 0.008″.

In an illustrated embodiment, the retention barb is located about 0.008″ to 0.0095″ along a length of the skin penetrating element from the backing, has a length of about 0.0001″, and tapers from a thickness of about 0.0001″ to a point at an angle of about 72°. Each skin penetrating element includes, e.g., two barbs.

The skin attachment member has a density of about 400 skin penetrating elements in a 0.01 in² area, i.e., 40,000/in². The skin penetrating elements are spaced apart from each other a distance of about 0.003″.

The skin attachment member is formed from nylon, polyethylene teraphthalate, or polyester. The skin attachment member is formed by molding.

In an illustrated embodiment, at least many of the skin penetrating elements define at least one groove in an outer surface of the skin penetrating elements. The skin penetrating elements are oriented perpendicular to the backing.

Other features and advantages of the invention will be apparent from the following description, and from the claims.

### BRIEF DESCRIPTION OF THE DRAWINGS

FIG. 1 is a highly magnified side view of a section of a skin attachment member according to the invention shown secured in the epidermis;

FIG. 2 is a diagrammatic perspective view of the section of the skin attachment member of FIG. 1;

FIG. 3A is a side view of a skin-penetrating element of the skin attachment member of FIG. 1;

FIG. 3B is a another side view of the element of FIG. 3A, rotated 90 degrees relative to FIG. 3A;

FIG. 3C is an end view of the element of FIG. 3A taken along lines 3C-3C in FIG. 3A;

FIG. 3D is a cross-sectional view of the element of FIG. 3A taken along lines 3D-3D in FIG. 3B;

FIG. 4 is a perspective view of section A of FIG. 3B showing a barb of the element of FIG. 3A;

FIG. 5 shows an alternative embodiment of a barb;

FIG. 6A is a diagrammatic representation of a molding machine for forming the skin attachment member of FIG. 1;

FIG. 6B shows a mold roll, pressure roll, and trim roller of the molding machine of FIG. 6A;

FIG. 6C is an enlarged view of the mold roll and pressure roll of the molding machine;

FIG. 7A is a side view of the mold roll of FIG. 6A;

FIG. 7B is a cross-sectional view of the mold roll, taken along lines 7B-7B in FIG. 7A;

FIG. 7C is an end view of the mold roll, taken along lines 7C-7C in FIG. 7B;

FIG. 7D is a magnified side view of portion 7D of the mold roll of FIG. 7A;

FIG. 7E shows laser machining of the mold roll; and

FIG. 8 shows an alterative edge formation on a mold roll.

### DESCRIPTION OF THE PREFERRED EMBODIMENTS

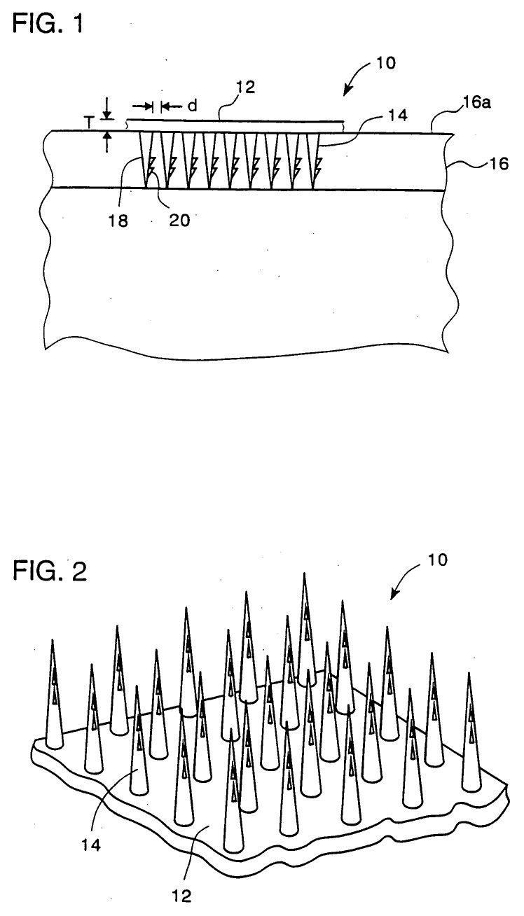

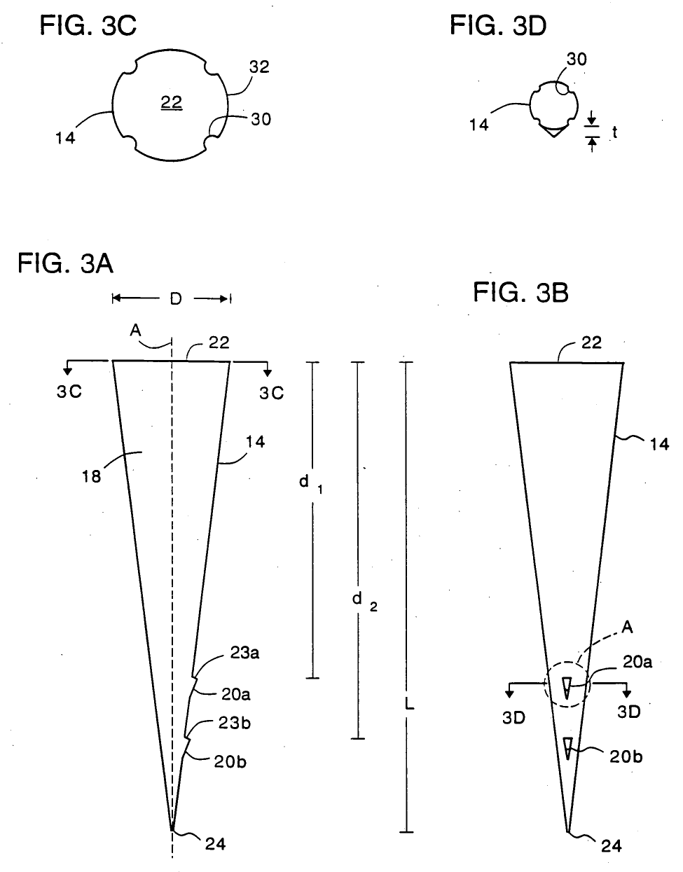

Referring to FIGS. 1 and 2, a skin attachment member 10, formed of plastic resin, includes a backing 12 and multiple, parallel rows of integrally molded, pointed projections or elements 14 extending from backing 12 for penetrating into the epidermis 16. The skin-penetrating elements 14 each include a cone-shaped body 18 with one or more discrete barbs 20 extending from the body for securing skin attachment member 10 to epidermis 16.

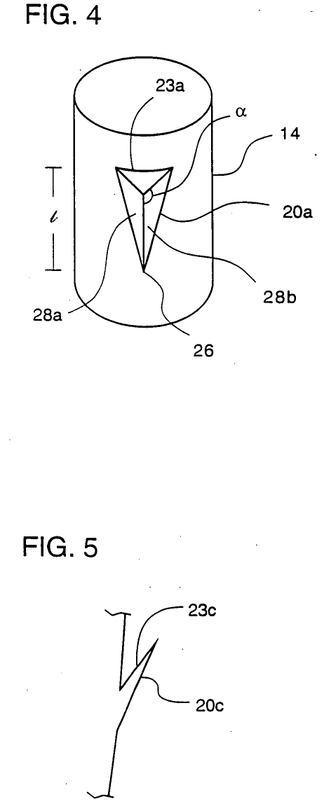

The length of elements 14 is selected such that they do not penetrate so far into the skin as to contact nerves located below the outer layers of the epidermis, as to cause significant pain and discomfort, but are long enough to cooperate with each other to provide sufficient adhesion to the skin. Elements 14 can be sized to extend into the portion of skin lying below the stratum corneum layer of the skin because of the small size of elements 14 and the spacing between nerves at this depth. For example, referring also to FIG. 3A, plastic elements 14 have a length, L, of about 0.012″. Since the thickness of the epidermis varies, for example, with age, the location on skin, and the gender of the patient, the length of elements 14 can be selected for the particular use.

Cone 18 tapers from a larger diameter proximal base 22 to a distal pointed tip 24. The conical shape and sharp point of elements 14 ease their penetration into epidermis 16. The diameter of base 22 is selected to be large enough to help prevent breaking off of the projecting elements 14 from backing 12, while limiting the size of the opening made in the outer surface 16a of epidermis 16. For example, cone 18 has a base diameter, D, of about 0.003″. Backing 12 has a thickness, T, in a range of about 0.003″ to 0.008″ to provide member 10 with sufficient handling characteristics.

The skin-penetrating projecting plastic elements 14 can be other than conical in shape. For example, elements 14 can be in the shape of a pyramid, a tetrahedron, or may be elliptical or square in cross-section, tapering to points at their distal ends. Rather than taper distally, elements 14 can progressively step down in diameter. Regardless of the particular shape selected, the elements 14 include sharp pointed tips 24 to ease tissue penetration.

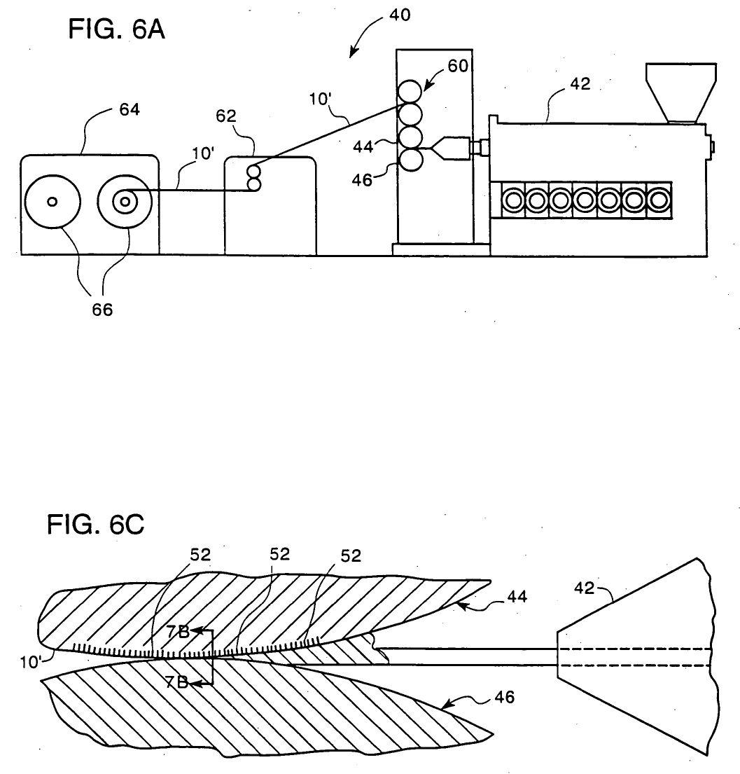

Referring to FIGS. 4A and 4B, projecting elements 14 are shown with two discrete barbs 20a, 20b for retaining elements 14 in the skin, though fewer or more barbs can be disposed on cone 28 to provide the desired retention characteristics. The location of barbs 20 can be selected to take advantage of the greater elasticity of the skin portions lying below the stratum corneum to provide greater holding force. For example, barb 20a has a top surface 23a located a distance, d₁, of about 0.008″ from base 22, and barb 20b has a top surface 23b located a distance, d₂, of about 0.0095″ from base 22.

Referring to FIG. 4, which is an enlarged view of section A of FIG. 3B, barbs 20a, 20b are roughly half-pyramids, each having a flat upper surface 23a which is perpendicular to a longitudinal axis, A, of the projecting element 14, and sloped sides 28a, 28b. Barbs 20a, 20b have a length, l, of about 0.0001″, and a thickness, t (FIG. 3d), of about 0.0001″, which tapers to a point 26 at an angle, α, of about 72°.

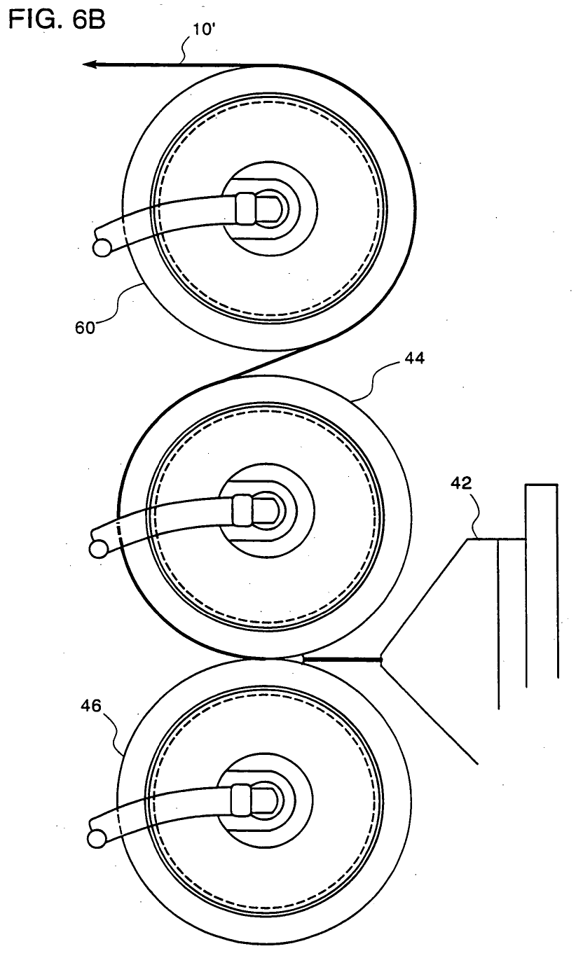

In use, due to the elasticity of the skin, member 10 is secured to skin surface 16a by surrounding of the barbs by the epidermis. To improve retention of member 10 to the skin, the barbs can be angled as shown in FIG. 5. Here, a barb 20c has a sloped upper surface 23c.

The density of projecting elements 14 on backing 12 depends on use. For example, in high strain applications, a higher density provides better skin attachment, whereas, in applications in which member 10 is not subjected to high strain, a lower density is better for limiting the possibility of inflammation. If the density is too high, it can require too much force for elements 14 to penetrate into the skin. A density of 400 projecting elements in a 0.1 in² area provides good skin attachment while not requiring excessive insertion force. In this case the projecting elements 14 are preferably spaced apart a distance, d (FIG. 1), of about 0.003″.

Member 10 and its projecting elements 14 are preferably formed from a thermoplastic, biocompatible polymer, which is stiff enough to penetrate skin but not brittle, and capable of filling a mold and retaining its molded form. Example of suitable polymers include nylon, polyethylene teraphthalate, and polyester.

Referring to FIGS. 3C and 3D, if desired for use in, for example, drug delivery, the projecting elements 14 include longitudinal grooves 30 in an outer surface 32 of cone 18, here four grooves 30 being shown, which provide passages for drug delivery. The penetration of elements 14 into the epidermis facilitates the delivery of drugs through the epidermis by reducing the thickness of the skin barrier to the vascular layer below the epidermis.

Other uses of member 10 include securing an intravenous or other catheter to the skin, such as securing in place a port for peritoneal dialysis, thus replacing a suture or a butterfly or acting secondary to a suture, acting as bandaid type wound closure to hold two sections of skin together, as wound covering, as a delivery system for self-delivery of drugs, in vetinary applications, as a reaction indicator, for time release vaccination, in agricultural applications such as bundle ties limiting damage to produce, and in geotextile applications. Incorporated in the polymer from which member 10 is formed can be bacteria killing agents or medication.

Skin attachment member 10 can be molded as a continuous strip 10′ according to the principles described in Fischer, U.S. Pat. No. 4,794,028, hereby incorporated by reference.

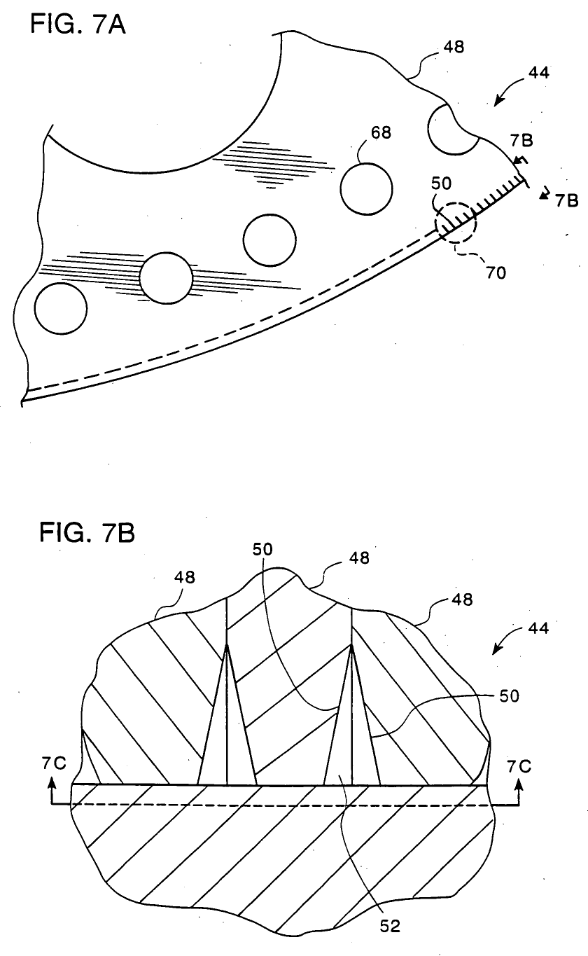

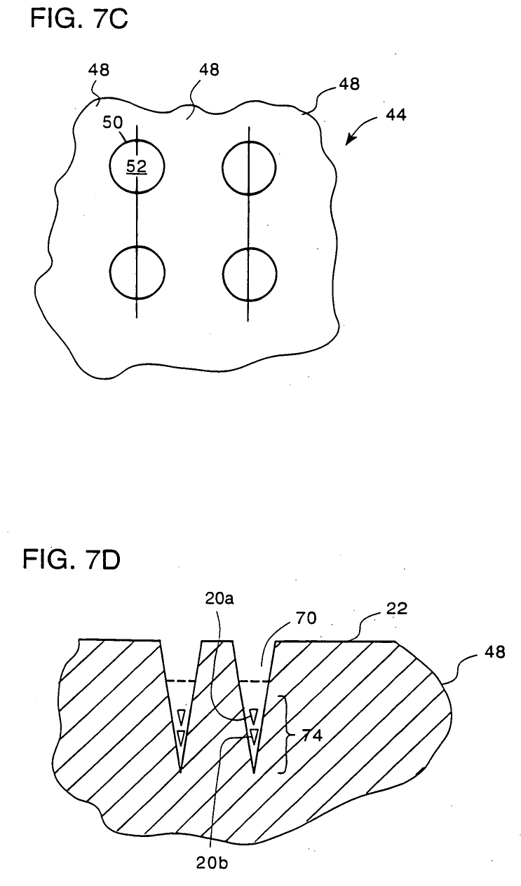

For example, referring to FIGS. 6A-6C, a molding machine 40 includes an extruder 42 which delivers an extrusion of molten plastic material between a pair of rollers 44, 46 mounted for rotation in opposite directions. Roller 44 is a cooled mold roll having a set of stacked parallel plates 48 (FIG. 7B) in which edge formations 50 define rows of projecting element-mold cavities 52. Roller 46 is a pressure roll which coacts with mold roll 44 for formation of continuous strip 10′.

Molten resin is continuously extruded and applied with pressure against mold roll 44 using pressure roll 46. Molten resin is forced into mold cavities 52 and between rolls 44, 46, to form the projecting elements 14 integral with backing 12. After cooling while on the roll, the continuous strip 10′ is stripped from mold roll 44, the projecting elements 14 undergoing temporary elastic deformation to achieve release from the mold cavities 52.

A trim roller assembly 60 is mounted above mold roll 44 such that continuous strip 10′ is removed or stripped from mold roll 44 immediately upstream of trim roller assembly 60. Trim roller assembly 60 can include two rollers, as shown FIG. 6A, or one roller, as shown in FIG. 6B. A tensioning roller assembly 62 creates tension in member 10 for effecting the removal of strip 10′ from mold roll 64. Downstream of tensioning roller assembly 62 is a winder 64 for winding continuous strip 10′ on spools 66 for subsequent shipment, storage and use.

Referring to FIGS. 7A and 7B, mold roll 44 includes a series of stacked plates 48 having edge formations 50 on either side of each plate. When stacked, plates 48 together define projecting element-forming cavities 52 within which projecting elements 14 are formed. Plates 48 also define water passages 68 for cooling of member 10′.

Referring to FIG. 7D, which is an enlarged view of section 7D of FIG. 7A, plates 48 of mold role 46 can be formed by etching a cone shape 70 for a length of about 0.004″ from roll edge 72. The remaining tip portion 74 of the cone is formed by laser machining (FIG. 7E) in which a laser 80, under computer position control, is used to remove material from the plate to form the tip portion. Barb impressions 20a′ and 20b′ can also be formed using laser machining. The laser can also be controlled to form grooves 30 in cone 18. The mold rolls are preferably formed of beryllium copper, the temperature of which is controlled during molding such that the resin does not cool too fast during application.

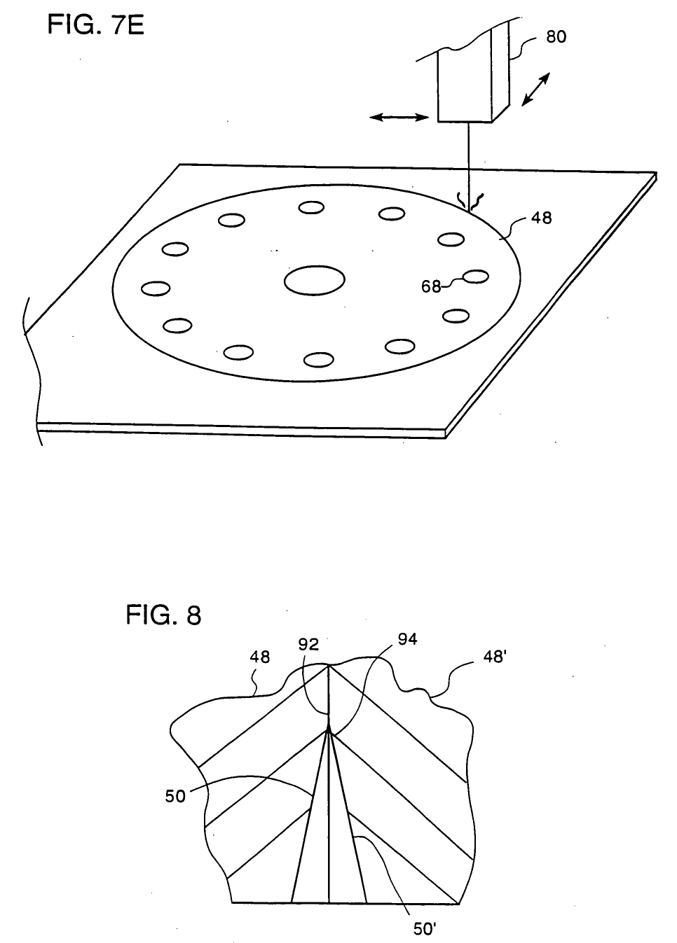

FIG. 8 shows an alternative embodiment of a mold cavity in which a first plate 48 defines an edge formation 50 as described above, and a second plate 48′ defines an edge formation 50′ having a tip 94 terminating prior to a tip 92 of edge formation 50. Thus, distal tip 24 of element 12 is defined by tip 92.

While skin attachment member 10 has been described as including multiple, parallel rows of projecting elements 14, the mold rolls can be arranged such that the rows of elements 14 are offset or otherwise distributed on backing 12. The projecting elements 14 can also be formed such that their longitudinal axes are not perpendicular to backing 12 or are distributed at various angles to backing 12. While enough of the projecting elements 14 should include barbs 20 to provide the desired degree of securement to the skin, not all of projecting elements 14 need include barbs 20.

Other embodiments are within the scope of the following claims.

1-18. (canceled)

19. A method of making a skin attachment member, the method comprising:
from a single plastic resin, forming an array of skin penetrating elements extending integrally from a backing, the skin penetrating elements sized to avoid contact with nerves below the epidermal skin layer during use; and
from the plastic resin, forming a discrete retention barb extending integrally from a surface of at least a plurality of the skin penetrating elements.

20. The method of claim 19, wherein forming the skin penetrating elements includes molding the array of skin penetrating elements, including each retention barb, integrally from the plastic resin.

21. The method of claim 20, wherein forming the skin penetrating elements includes introducing the plastic resin in molten form to a gap formed adjacent a periphery of a rotating mold roll having multiple skin penetrating element forming cavities extending inwardly from the periphery such that the plastic resin fills ones of the skin penetrating element forming cavities while excess plastic resin forms the backing.

22. The method of claim 21, wherein at least some of the skin penetrating element cavities include barb impressions for molding the discrete retention barbs from the plastic resin.

23. The method of claim 22 including cooling the plastic resin within the skin penetrating element forming cavities.

24. The method of claim 23 including, after cooling the plastic resin, stripping the plastic resin forming the skin penetrating elements, including any associated retention barb, from the skin penetrating element forming cavities.

25. The method of claim 24, wherein stripping the plastic resin includes temporarily elastically deforming the molded skin penetrating elements to achieve release from the skin penetrating element forming cavities.

26. The method of claim 21, wherein introducing the plastic resin includes extruding the plastic resin.

27. The method of claim 21, wherein the plastic resin is continuously introduced to the gap to mold a continuous strip of the array of skin penetrating elements.

28. The method of claim 27 including winding the continuous strip of the array of fastener elements for storage or transport.

29. The method of claim 21, wherein the gap is in the form of a nip defined between the mold roll and a counter-rotating pressure roll.

30. A method of delivering a drug to a subject, the method comprising
providing a member comprising a backing and an array of skin penetrating elements extending integrally from a surrounding surface of the backing to a tip and sized to avoid contact with nerves below an epidermal skin layer of the subject when the skin penetrating elements fully penetrate the epidermal skin layer, wherein a plurality of the skin penetrating elements each define a longitudinal groove in an outer surface thereof, and wherein the array of skin penetrating elements are formed integrally of a single plastic resin;
penetrating the epidermal skin layer of the subject with the skin penetrating elements; and
delivering the drug to the subject along the longitudinal grooves on the skin penetrating elements.

31. The method of claim 30, wherein a plurality of the skin penetrating elements each includes a retention barb extending from an outer surface of the skin penetrating element.

32. The method of claim 30, wherein the skin penetrating elements are formed from a biocompatible polymer.

33. The method of claim 30, wherein the member is formed from a polymer selected from the group consisting of nylon, polyethylene, teraphthalate, and polyester.

34. A method of attaching a skin attachment member to an epidermal skin layer of a subject, the method comprising;
providing a skin attachment member comprising a backing and an array of skin penetrating elements extending integrally from a surrounding surface of the backing to a tip and sized to avoid contact with nerves below the epidermal skin layer when the skin penetrating elements fully penetrate the epidermal skin layer, wherein a plurality of the skin penetrating elements each includes a retention barb extending from an outer surface of the skin penetrating element, and wherein the array of skin penetrating elements, including each retention barb, is formed integrally of a single plastic resin;
positioning the skin attachment member on the epidermal skin layer of the subject; and
applying sufficient pressure to the skin attachment member to cause penetration of the skin penetrating elements into the epidermal skin layer, such that the retention barbs resist removal of the attachment member from the epidermal skin layer.

35. The method of claim 34, wherein each skin penetrating element includes a retention barb.

36. The method of claim 34, wherein at least a plurality of the skin penetrating elements include two retention barbs.

37. The method of claim 34, wherein the skin attachment member is formed from a polymer selected from the group consisting of nylon, polyethylene, teraphthalate, and polyester.

38. The method of claim 34, wherein a plurality of the skin penetrating elements comprise longitudinal grooves for the delivery of a drug to a subject.
